(19) United States
(12) Patent Application Publication
(10) Pub. No.: US 2010/0056035 A1
(43) Pub. Date: Mar. 4, 2010

(54) Replaceable Aerator for Recreational Vehicle

(76) Inventor: Chong Hua, Hangzhou (CN)

Correspondence Address: GLOBAL IP SERVICES, 7285 W. Eagle Court, Winton, CA, 95388, US

(21) Appl. No.: 12/419,496

(22) Filed: Apr. 7, 2009

(30) Foreign Application Priority Data
Sep. 1, 2008 (CN) 200820163373.0

(51) Int. Cl. B60H 1/24

(52) U.S. Cl. 454/139

(57) ABSTRACT

A replaceable aerator for recreational vehicle mainly comprises an air bleeder cap, a metal frame under the air bleeder cap and fixed on the air vent of the ceiling and a ventilating device fixed on the metal frame. The air bleeder cap and the metal frame are connected by a hinge on one side and the air bleeder cap is pivoted about the hinge. The ventilating device has a bottom frame fixed on the metal frame. The motor shell, motor and fan blade are installed inside the bottom frame. The fan blade is fixed with the transmission shaft of the motor and is protected by a wire mesh on its periphery. The device is simple in structure, easy for use, effective in ventilation and easy in replace.

### CROSS REFERENCE TO RELATED PATENT APPLICATION

The present application claims the priority of the Chinese patent application No. 200820163373.0 filed on Sep. 1, 2008, which application is incorporated herein by reference.

### FIELD OF THE INVENTION

The invention is a kind of ventilating device for motor vehicle and is belong to technical field of ventilating device.

### BACKGROUND OF THE INVENTION

Before the invention is developed, the motor vehicle, especially the recreational vehicle, has no ventilating device, passengers stay in the vehicle long time will feel uncomfortable, and the air quality in the vehicle is poor. Some vehicles have a ventilating device on the car ceiling, which is simple, may be an air bleeder cap only or an air bleeder cap with a fanned aerator below. The air bleeder cap with a fanned aerator is capable of achieving automatic ventilation. However, the maintenance and repair are very difficult. As the fan is controlled by motor it is extremely inconvenient to replace the motor or fan in case of damage in use. Also, the operation of opening or closing air bleeder cap is quite inconvenient.

### SUMMARY OF THE INVENTION

The purpose of the invention is to overcome the above mentioned deficiencies and provides a replaceable aerator for recreational vehicle; it is simple in structure, easy to use and effective in ventilation.

The invention achieves the purpose by following technical scheme: a replaceable aerator for recreational vehicle is composed of an air bleeder cap, a metal frame under the cap and installed on the air vent of the ceiling and a ventilating device on the metal frame. The air bleeder cap and metal frame are connected by a hinge at one side of the air bleeder cap. The air bleeder cap is pivoted about the hinge to close or open the air vent. The ventilating device has a bottom frame fixed on the metal frame. Inside the bottom frame there are motor shell, motor and fan blade. The fan blade is fixed on the transmission shaft of the motor and the fan blades are protected by a wire mesh on its periphery.

A traverse bar with a groove is fixed on the air bleeder cap. Also a transverse bar is installed on the metal frame, a driving unit is fixed on the transverse bar and a worm rod is built into the driving unit. The traverse bar on the air bleeder cap and the traverse bar on the metal frame are connected by a connection rod. One end of the connection rod is moveably connected with the groove on the traverse bar of air bleeder cap, the other end is shaped as worm gear and is meshed with the worm rod.

The driving unit comprises of a gear cover, a gear stand, an active gear, a passive gear and a cranking handle. The active gear and the passive gear are meshed and installed on the gear stand. The active gear connects the cranking handle via the gear shaft. The passive gear is connected to one end of the above mentioned worm rod by key-connection.

The replaceable aerator for recreational vehicle is installed on the ceiling inside the motor vehicle, especially the recreational vehicle. It provides two options, i.e. fan or skylight, for user. The device is simple in structure, easy for use, effective in ventilation and easy in replaceable.

### BRIEF DESCRIPTIONS OF THE DRAWINGS

FIG. 1 is an explosive view of the replaceable aerator for recreational vehicle of the present invention.

FIG. 2 is a perspective view showing the driving unit of the replaceable aerator.

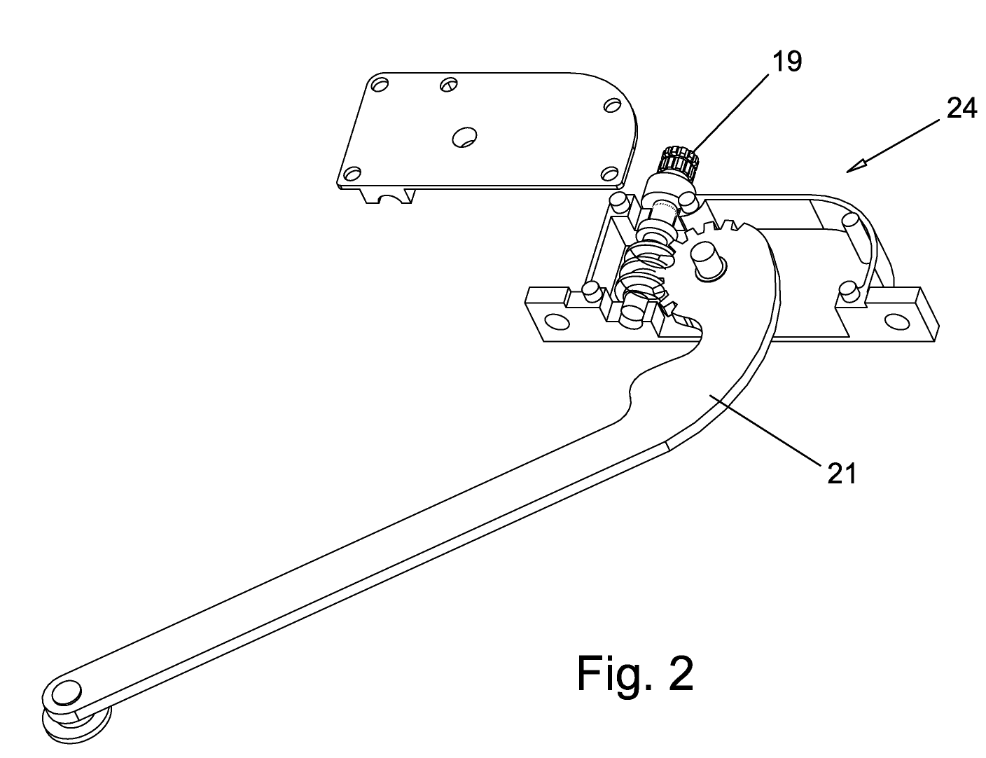

FIG. 3 is a perspective view showing the air bleeder cap of the replaceable aerator.

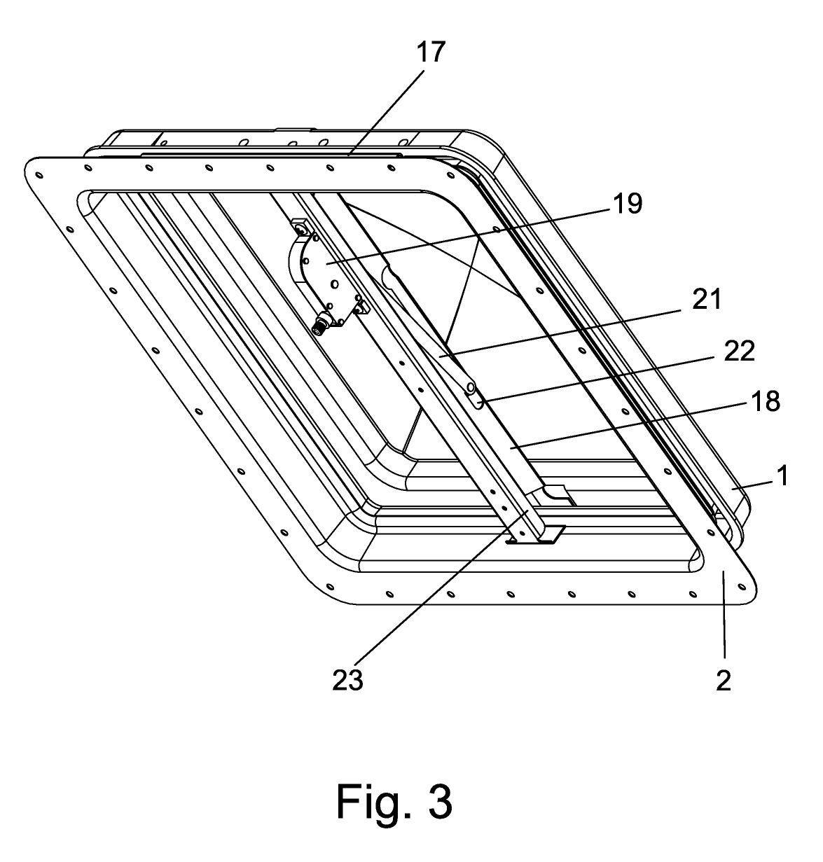

### DETAIL DESCRIPTION OF THE INVENTION

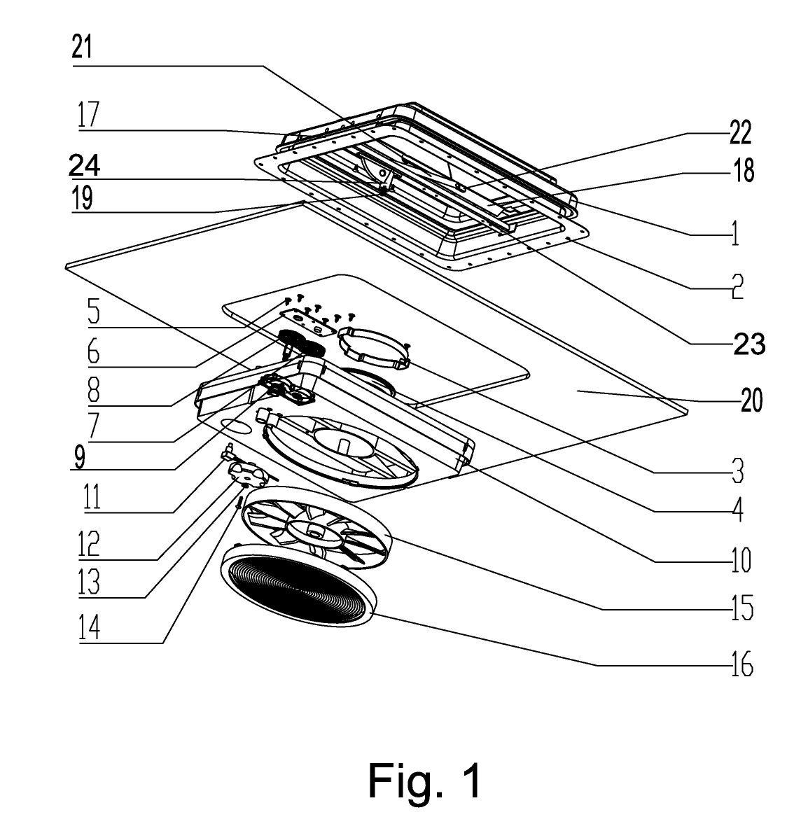

Below is the detailed introduction of the invention with reference of the attached drawings: FIG. 1 presents three-dimension exploded view of the replaceable aerator for recreational vehicle. The drawing shows a quadrangle plastic air bleeder cap 1 and a quadrangle metal frame 2 connected to the air bleeder cap 1. The metal frame 2 is installed on the air vent of the ceiling 20 and serves as a skylight of an ordinary vehicle. A ventilating device is installed on the metal frame. The air bleeder cap 1 and metal frame 2 are connected by a hinge 17 on its side. The air bleeder cap 1 can pivot about the hinge 17 to open or close the air vent. A traverse bar 18 with groove 22 in middle is fixed on the air bleeder cap 1. The traverse bar 23 is installed on metal frame 2, a driving unit 24 is fixed to the traverse bar 23 by a thread and the worm rod 19 is built into the driving unit 24.

The traverse bar 18 on the air bleeder cap 1 and the traverse bar 23 on the metal frame 2 are connected by a connection rod 21. One end of the connection rod can move along the groove 22 on the traverse bar 18 of air bleeder cap 1, the other end is shaped as worm gear and meshed to worm rod 19. Turns the worm rod 19 via the driving unit 24, the connection rod 21 will be turned to push or pull the air bleeder cap 1 to open or close the air vent. Moreover, the driving mechanism can be easily replaced.

The ventilating device comprises a bottom frame 10, which is fixed on the metal frame 2 by screw 5. Motor shell 3, motor 4 and fan blade 15 are built inside the bottom frame 10. The central shaft of the fan blade 15 is equipped on the transmission shaft of the motor 4, the motor shell 3 is installed outside of the motor 4, the motor switch 11 is installed outside of the bottom frame 11, and the protective wire mesh 16 is equipped on the periphery of the fan blade 15. The above mentioned ventilating device can also be replaced.

The driving unit 24 comprises of gear cover 6, gear stand 9, active gear 8, passive gear 7 and cranking handle 12. The active gear 8 and passive gear 7 are meshed and installed on the gear stand 9. The active gear 8 connects the cranking handle 12 via the gear shaft. The passive gear 7 connects one end of the worm rod by a kind of key connection, such as spline. After the assembly, turn the cranking handle 12, through the active gear 8, passive gear 7 connection rod and eventually manipulates the air bleeder cap 1.

Although the present invention and its advantages have been described in detail, it should be understood that the present invention is not limited to or defined by what is shown or described herein. As one of ordinary skill in the art will appreciate, various changes, substitutions, and alterations could be made or otherwise implemented without departing from the principles of the present invention. Accordingly, the scope of the present invention should be determined by the following claims and their legal equivalents.

What is claimed is:

1. A replaceable aerator for recreational vehicle comprising: an air bleeder cap;
a metal frame, which is connected with the air bleeder cap and fixed on an air vent of ceiling 20;
a ventilating device, which is fixed on the metal frame;
the air bleeder cap 1 being connected to the metal frame 2 by a hinge 17 on its side and pivoted about the hinge 17; and
the ventilating device including a bottom frame 10 fixed on the metal frame 2, a motor shell 3, motor 4 and fan blade 15 being built inside the bottom frame, the fan blade 15 being fixed on a transmission shaft of the motor and protected by a wire mesh.

2. The replaceable aerator for recreational vehicle of claim 1, wherein a traverse bar 18 with a groove 22 in the middle is fixed on the air bleeder cap 1, a traverse bar 23 is installed on the metal frame 2, a driving unit 24 is fixed on the traverse bar 23 of the metal frame 2 and a worm rod 19 is built into the driving unit 24; the traverse bar 18 on the air bleeder cap 1 and the traverse bar 23 on the metal frame 2 are connected by a connection rod 21; one end of the connection rod 21 is movable along the groove 22 on the traverse bar 18, the other end of the connection rod 21 is shaped as worm gear to mesh with the worm rod 19.

3. The replaceable aerator for recreational vehicle of claim 1, wherein the driving unit 24 comprises a gear shell 6, gear stand 9, active gear 8, passive gear 7 and cranking handle 12, the active gear 8 and the passive gear 7 are meshed and installed on the gear stand 9, the active gear 8 connects the cranking handle 12 via a gear shaft, the passive gear 7 connects the worm rod 19 by key-connection.
